(19) United States
(12) Patent Application Publication
(10) Pub. No.: US 2012/0163035 A1
(43) Pub. Date: Jun. 28, 2012

(54) MULTI-PHASE INTERLEAVED BIDIRECTIONAL DC-DC CONVERTER

(75) Inventors: Yujin Song, Daejeon-si (KR); Soo-Bin Han, Daejeon-si (KR); Sukin Park, Daejeon-si (KR); Hak-Geun Jeong, Daejeon-si (KR); Su-Yong Chae, Daejeon-si (KR); Gyu-Duk Kim, Daejeon-si (KR); Seung-Weon Yu, Daejeon-si (KR)

(73) Assignee: KOREA INSTITUTE OF ENERGY RESEARCH, Daejeon-si (KR)

(21) Appl. No.: 12/979,925

(22) Filed: Dec. 28, 2010

(30) Foreign Application Priority Data
Dec. 24, 2010 (KR) 10-2010-0134367

(51) Int. Cl. H02M 3/335

(52) U.S. Cl. 363/17

(57) ABSTRACT

Provided is power conversion technology for charge and discharge control of an energy storage module such as battery or super capacitor. For achieving the technology, there is provided a multi-phase interleaved bidirectional DC-DC converter including: a first bidirectional DC-DC converter including a input unit which includes a first input inductor and an energy storage module which stores input current from the energy storage module, a first primary-side half-bridge which is connected to the first input inductor of the input unit and controls the input current from the energy storage module, an output unit which includes an output capacitor, a first secondary-side half-bridge which is connected to the output unit and controls the output voltage, and a first transformer whose primary side is connected to the first primary-side half-bridge, whose secondary side is connected to the first secondary-side half-bridge, and which transforms a voltage at the primary side or at the secondary side according to a power mode; and a n-th bidirectional DC-DC converter, wherein the n-th bidirectional DC-DC converter is composed of one or more n-th bidirectional DC-DC converters.

### CROSS-REFERENCE TO RELATED APPLICATION

This application claims the benefit under 35 U.S.C. §119(a) of a Korean Patent Application No. 10-2010-0134367, filed on Dec. 24, 2010, the entire disclosure of which is incorporated herein by reference for all purposes.

### BACKGROUND

1. Field

The following description relates to a bidirectional DC-DC converter, and more particularly, to a multi-phase interleaved bidirectional DC-DC converter for energy storage system applications.

2. Description of the Related Art

Recently, the need for development of an environment-friendly vehicle increases rapidly due to the shortage of fossil fuel and global warming. A hybrid electric vehicle and plug-in electric vehicle are in the spotlight as an alternative for the conventional vehicle with internal combustion engine. The hybrid electric vehicle and plug-in electric vehicle adopt a large capacity of battery or super capacitor as an auxiliary or main power source, where a bidirectional DC-DC converter with high voltage conversion ratio is required to control the charge and discharge of low voltage energy storage system. Since the bidirectional DC-DC converter affects the battery lifetime and the performance of electric vehicle, it should be designed to be efficient and reliable as well as compact and light.

### SUMMARY

The following description relates to power conversion technology of controlling charge and discharge of the energy storage system such as battery or super capacitor.

In one general aspect, there is provided a multi-phase interleaved bidirectional DC-DC converter including: a first bidirectional DC-DC converter including an input unit which includes an energy storage module and a first input inductor storing input current from the energy storage module, a first primary half-bridge which is connected to the first input inductor of the input unit and controls the input current from the energy storage module, an output unit which stores an output voltage, a first secondary half-bridge which is connected to the output unit and controls the output voltage, and a first transformer whose primary side is connected to the first primary half-bridge, whose secondary side is connected to the first secondary half-bridge, and which transforms a voltage at the primary side or at the secondary side according to a power mode; and a n-th bidirectional DC-DC converter including a n-th input inductor which stores input current from the energy storage module, a n-th primary half-bridge which is connected to the n-th input inductor and controls the input current from the energy storage module, a n-th secondary half-bridge which is connected to the output unit of the first bidirectional DC-DC converter and controls the output voltage, and a n-th transformer whose primary side is connected to the n-th primary half-bridge, whose secondary side is connected to the n-th secondary half-bridge, and which transforms a voltage at the primary side or at the secondary side according to a power mode, wherein the n-th bidirectional DC-DC converter is composed of one or more n-th bidirectional DC-DC converters.

The first bidirectional DC-DC converter further includes an output capacitor, the first input inductor of the input unit is connected to the energy storage module, the first primary half-bridge includes a first primary switch connected to the first input inductor, a second primary switch, a first capacitor, and a second capacitor, the first secondary half-bridge includes a first secondary switch, a second secondary switch, a third capacitor, and a fourth capacitor, which are connected to the output capacitor, and the primary-side one end of the first transformer is connected to a contact of the first primary switch and the second primary switch, the primary-side other end of the first transformer is connected to a contact of the first capacitor and the second capacitor, the secondary-side one end of the first transformer is connected to a contact of the first secondary switch and the second secondary switch, and the secondary-side other end of the first transformer is connected to a contact of the third capacitor and the fourth capacitor.

The n-th bidirectional DC-DC converter further includes an output capacitor, the n-the input inductor is included in the input unit and connected to the energy storage module, the n-th primary half-bridge includes a n-th primary switch connected to the n-th input inductor, a (n+1)-th primary switch, the first capacitor, and the second capacitor, the n-th secondary half-bridge includes a n-th secondary switch, a (n+1)-th secondary switch, the third capacitor, and the fourth capacitor, which are connected to both terminals of the output capacitor, and the primary-side one end of the n-th transformer is connected to a contact of the n-th primary switch and the (n+1)-th primary switch, the primary-side other end of the n-th transformer is connected to a contact of the first capacitor and the second capacitor, the secondary-side one end of the n-th transformer is connected to a contact of the n-th secondary switch and the (n+1)-th secondary switch, and the secondary-side other end of the n-th transformer is connected to a contact of the third capacitor and the fourth capacitor.

In one general aspect, there is provided a 3-phase interleaved bidirectional DC-DC converter including: an energy storage module; three input inductors connected in parallel to each other and connected to the energy storage module; three primary half-bridges connected to the three input inductors, respectively; an output capacitor; three secondary half-bridges connected to both terminals of the output capacitor and provided respectively in correspondence to the three primary half-bridges; and a 3-phase high frequency transformer connected to the three primary half-bridges and the three secondary half-bridges in a Y-Y connection form.

Therefore, it is possible to effectively control charge and discharge of an energy storage system such as battery or super capacitor. Since the multi-phase interleaved bidirectional DC-DC converter is a kind of current-fed DC-DC converter, it can achieve a high step-up ratio with a low turn ratio of transformer. Also, by minimizing switching loss by allowing zero voltage switching with respect to all primary- and secondary-side switching devices included in the converter, and minimizing conduction loss of each device through parallel operation of a plurality of bidirectional DC-DC converters, a high-efficient bidirectional DC-DC converter for battery charge/discharge can be implemented. Meanwhile, as the capacity of energy storage module increases, the multi-phase interleaved bidirectional DC-DC converter can be extended in each phase by adding a bidirectional DC-DC converter, and the current ripple due to a high frequency switching operation of the converter can be minimized through interleaved parallel operation. Moreover, the multi-phase interleaved bidirectional DC-DC converter requires no voltage clamping circuit although it is a current-fed DC-DC converter, which contributes to a cost reduction.

Other features and aspects will be apparent from the following detailed description, the drawings, and the claims.

### BRIEF DESCRIPTION OF THE DRAWINGS

FIG. 1 is a circuit diagram illustrating an example of a multi-phase interleaved bidirectional DC-DC converter.

FIG. 2 is a circuit diagram illustrating an example of a 3-phase interleaved bidirectional DC-DC converter.

FIG. 3 is waveforms for explaining the operation waveforms of the 3-phase interleaved bidirectional DC-DC converter.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

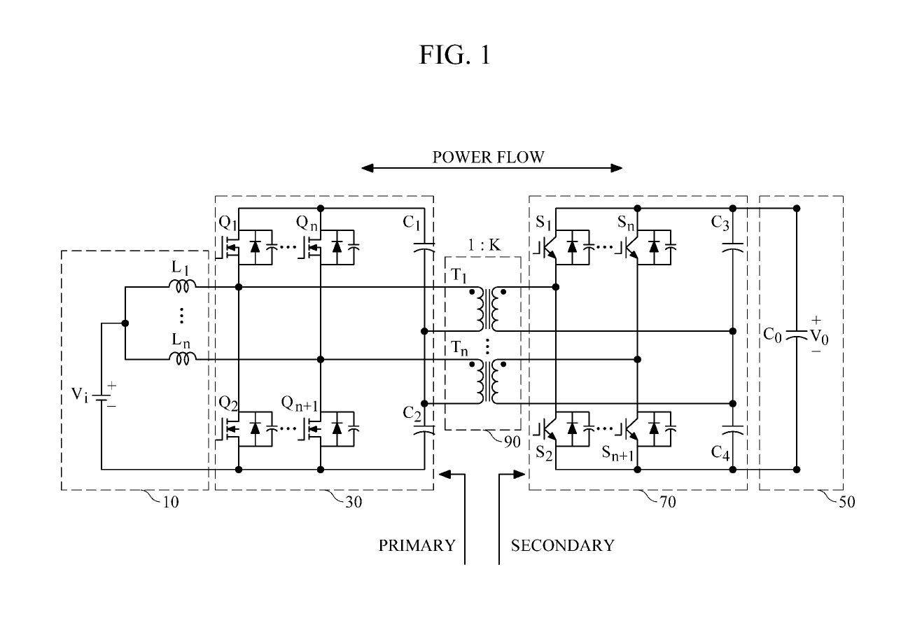

FIG. 1 is a circuit diagram illustrating an example of a multi-phase interleaved bidirectional DC-DC converter.

Referring to FIG. 1, the multi-phase interleaved bidirectional DC-DC converter includes an input unit 10, two or more primary half-bridges 30, an output unit 50, two or more secondary half-bridges 70, and two or more transformers 90. In detail, the input unit 10 includes an energy storage module V, and multiple input inductors L₁, . . . , Lₙ in parallel connection connected to the energy storage module Vᵢ, the primary half-bridges 30 include capacitors C₁ and C₂ and a plurality of switches Q₁, Qₙ, Qₙ₊₁ connected to the input unit 10, the output unit 50 has both terminals of an output capacitor C₀ as its output, the second half-bridges 70 include capacitors C₃ and C₄ and a plurality of switches S₁, S₂, Sₙ, Sₙ₊₁ connected to the output unit 50, and the transformers 90, whose one ends are connected to the primary half-bridges 30 and whose other ends are connected to the secondary half-bridges 79, steps up the primarily voltage by a voltage conversion ratio.

As described above, the input unit 10 includes an energy storage module Vᵢ and a plurality of input inductors L₁, . . . , Lₙ connected in parallel to each other and connected respectively to the energy storage module Vᵢ, and the energy storage module Vᵢ is a battery or a super capacitor allowing charge/discharge of energy. The input inductors L₁, . . . , Lₙ are respectively connected in series to the energy storage module Vᵢ. The input inductors L₁, . . . , Lₙ to store current from the energy storage module Vᵢ as an energy, and the stored energy is transmitted to the secondary sides via the primary half-bridges 30 and the transformers 90.

The primary half-bridges 30 basically include two switches Q₁ and Q₂ and two capacitors C₁ and C₂. In this case, the primary half-bridges 30 are positioned at the primary sides of the transformers 90. The switches Q₁ and Q₂ are Insulated Gate Bipolar Transistors (IGBTs) or MOS Field-Effect Transistors (MOSFETs). Each of the switches Q₁ and Q₂ has a lossless capacitor in parallel connection. The lossless capacitor is used for soft switching implementation. In the multi-phase interleaved bidirectional DC-DC converter, the primary sides have a lower voltage than the secondary sides. When the multi-phase interleaved bidirectional DC-DC converter is in a boost mode, the energy flows from the energy storage module of the primary side to the output terminal of the secondary side.

The primary half-bridges 30 are connected to the input unit 10 and the transformers 90. Also, the primary half-bridges 30 allow zero voltage switching. When the multi-phase interleaved bidirectional DC-DC converter is in the boost mode, the primary half-bridges 30 modulate DC current from the energy storage module Vᵢ of the input unit 10 to the high frequency current pulses and transmit them to the secondary side through the transformers 90. The secondary half-bridges 70 rectify the high frequency current pulses and transmit the rectified current to the output unit 50. When the multi-phase interleaved bidirectional DC-DC converter is in a buck mode, the primary half-bridges 30 rectify the high frequency current pulses received from the secondary half-bridge 70 through the transformers 90 and transmit the rectified current to the input unit 10.

As the capacity of energy storage module increases, the multi-phase interleaved bidirectional DC-DC converter can be extended in each phase by adding a bidirectional DC-DC converter. If a bidirectional DC-DC converter is added to the multi-phase interleaved bidirectional DC-DC converter, an input inductor Lₙ is added to the input unit 10 and a primary half-bridge 30 connected to the added input inductor Lₙ includes two switches (for example, Qₙ and Qₙ₊₁). Accordingly, when another bidirectional DC-DC converter is added to the multi-phase interleaved bidirectional DC-DC converter, the input unit 10 of the entire DC-DC converter additionally includes an inductor and the primary half-bridges 30 additionally include two switches.

The output unit 50 includes a capacitor C₀. The multi-phase interleaved bidirectional DC-DC converter according to the current example has a single output. The output unit 50 of the multi-phase interleaved bidirectional DC-DC converter may be connected to a DC input terminal of a grid-connected inverter, to a DC output terminal of a distributed generation converter or to a DC input terminal of a load converter.

When the multi-phase interleaved bidirectional DC-DC converter is in the boost mode, the energy flows from the input unit 10 to the output unit 50. The energy is stored in the capacitor C₀ of the output unit 50, and then transferred to the external power system. When the multi-phase interleaved bidirectional DC-DC converter is in a buck mode, the energy flows from the output unit 50 to the input unit 10. In this case, the capacitor C₀ of the output unit 50 stores the energy transmitted from the external power system and then transmits the energy to the input unit 10 via the secondary half-bridges 70 and transformers 90.

The secondary half-bridges 70 basically include two switches S₁ and S₂ and two capacitors C₃ and C₄. In this case, the secondary half-bridges 70 are positioned at the secondary sides of the transformers 90. The switches S₁ and S₂ also are IGBTs or MOSFETs. Each of the switches S₁ and S₂ has a lossless capacitor in parallel connection. The lossless capacitor is used for soft switching implementation.

In the multi-phase interleaved bidirectional DC-DC converter, the primary side has a lower voltage than the secondary side. When the multi-phase interleaved bidirectional DC-DC converter is in the buck mode, energy flows from the secondary side (high voltage) to the primary side (low voltage), whereas when the multi-phase interleaved bidirectional DC-DC converter is in the boost mode, the energy flows from the primary side to the secondary side. When the multi-phase interleaved bidirectional DC-DC converter is in the buck mode, the secondary half bridges 70 modulates the DC current of the output unit 50 to high frequency current pulses and transmit them to the primary side through the transformers 90. Meanwhile, when the multi-phase interleaved bidirectional DC-DC converter is in the boost mode, the secondary half-bridges 70 rectify the pulse current transmitted through the transformers 90 and transmit the rectified current to the output unit 50.

The multi-phase interleaved DC-DC converter according to the current example can be extended in each phase by adding a bidirectional DC-DC converter. When another bidirectional DC-DC converter is added to the multi-phase interleaved bidirectional DC-DC converter, an input inductor Lₙ is added to the input unit 10 and a primary half-bridge 30 connected to the added input inductor Lₙ includes two switches Qₙ and Qₙ₊₁, and the secondary half-bridges 70 corresponding to the primary half-bridges 30 also include two switches Sₙ and Sₙ₊₁. Accordingly, when another bidirectional DC-DC converter is added to the multi-phase interleaved bidirectional DC-DC converter, the secondary half-bridges of the entire converter additionally include two switches.

The transformers 90 transform a voltage from the primary side and apply the transformed voltage to the secondary side. The transformer 90 electrically isolates the energy storage module from the load. The transformers 90 have a predetermined turn ratio of 1:K and transform a voltage from the primary side. The transformers 90 step up the primary voltage by a voltage conversion ratio. In the multi-phase interleaved bidirectional DC-DC converter, an input inductor is added to the input unit 10, and two switches are added to each of the primary half-bridges 30 and secondary half-bridges 70 whenever a new bidirectional DC-DC converter is added. Accordingly, whenever a new bidirectional DC-DC converter is added to the multi-phase interleaved bidirectional DC-DC converter, a transformer is added to each pair of the primary half-bridges 30 and secondary half-bridges 70.

FIG. 1 detailedly shows the connection relationship of circuit components that configure the multi-phase interleaved bidirectional DC-DC converter. If the multi-phase interleaved bidirectional DC-DC converter is a n-phase bidirectional DC-DC converter, an energy storage module Vᵢ, and n input inductors L₁, . . . , Lₙ in parallel connection are connected in series to the energy storage module Vᵢ. A primary half-bridge is connected to one of the input inductors L₁, . . . , Lₙ. The primary half-bridge includes two primary switches Q₁ and Q₂ and two capacitors C₁ and C₂. If another bidirectional DC-DC converter is added to the multi-phase interleaved bidirectional DC-DC converter, another primary half-bridge is also added with an input inductor. In this case, two switches (for example, Qₙ and Qₙ₊₁) are added and the capacitors C₁ and C₂ are shared with the other primary half-bridges.

The n-phase bidirectional DC-DC converter includes a plurality of transformers T₁, . . . , Tₙ. Each of the transformers T₁, . . . , Tₙ is a high frequency transformer and is connected to both the primary and secondary side, that is, to both the primary and secondary half-bridges, in a Y-Y connection form. In this case, one ends of the primary sides of the transformers T₁, . . . , Tₙ are connected to contacts of the switches Q₁, . . . , Qₙ, Qₙ₊₁ included in the primary half-bridges, and the other ends of the primary sides of the transformers T₁, . . . , Tₙ are connected to a contact of the capacitors C₁ and C₂ of the primary half-bridges. In detail, one end of the primary side of each of the transformers T₁, . . . , Tₙ is connected to a contact of two switches belonging to different primary half-bridges, and the other end of the primary side of each of the transformers T₁, . . . , Tₙ is connected to the contact of the capacitors C₁ and C₂ at the same primary side. When a new bidirectional DC-DC converter is added to the multi-phase interleaved bidirectional DC-DC converter, an input inductor Lₙ is added to the input unit 10 and two switches (for example, Qₙ and Qₙ₊₁) are added to configure a primary half-bridge connected to the added input inductor Lₙ, while the capacitors C₁ and C₂ are shared with the primary half-bridges of other bidirectional DC-DC converters.

One end of the secondary side of each of the transformers T₁, . . . , Tₙ is connected to the contact of two switches belonging to the corresponding secondary half-bridge, and the other end of the secondary side of each of the transformers T₁, . . . , Tₙ is connected to the contact of capacitors C₃ and C₄ of the secondary half-bridge. In detail, one end of the secondary side of each of the transformers T₁, . . . , Tₙ is connected to the contact of two switches included in different secondary half-bridges, and the other end of the secondary side of each of the transformers T1, . . . , Tn is connected to the contact of capacitors C₃ and C₄ at the same secondary side. When a new bidirectional DC-DC converter is added to the multi-phase interleaved bidirectional DC-DC converter, two switches Sₙ and Sₙ₊₁ are added to configure a second half-bridge, while the capacitors C₃ and C₄ are shared with secondary half-bridges of other bidirectional DC-DC converter.

A secondary half-bridge includes two switches (for example, S₁ and S₂) and the two capacitors C₃ and C₄. Whenever a new bidirectional DC-DC converter is added to the multi-phase interleaved bidirectional DC-DC converter, another secondary half-bridge is also added. In this case, the secondary half-bridge, which is newly added, is composed by adding two switches (for example, and Sₙ₊₁) and sharing the capacitors C₃ and C₄ with other secondary half-bridges. The multi-phase interleaved bidirectional DC-DC converter according to the current example includes a single output capacitor C₀. Accordingly, a plurality of secondary half-bridges are connected to the single output capacitor C₀.

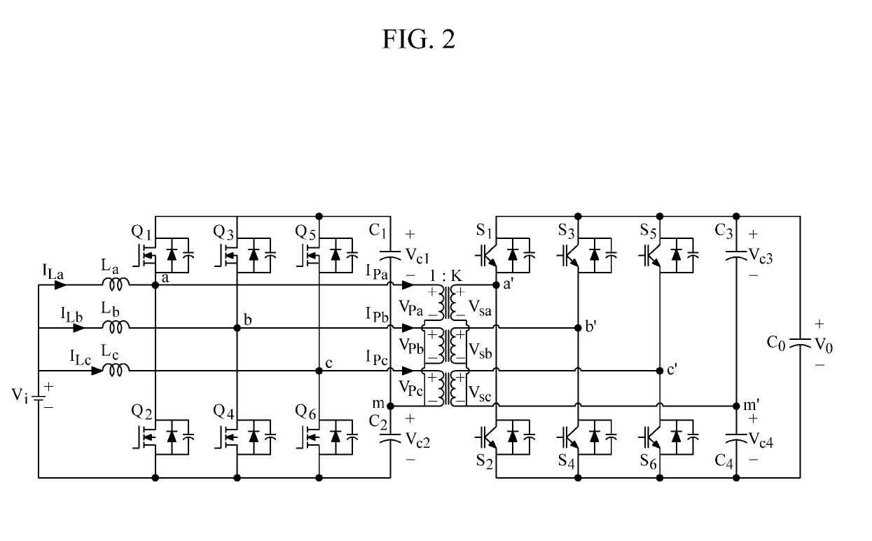

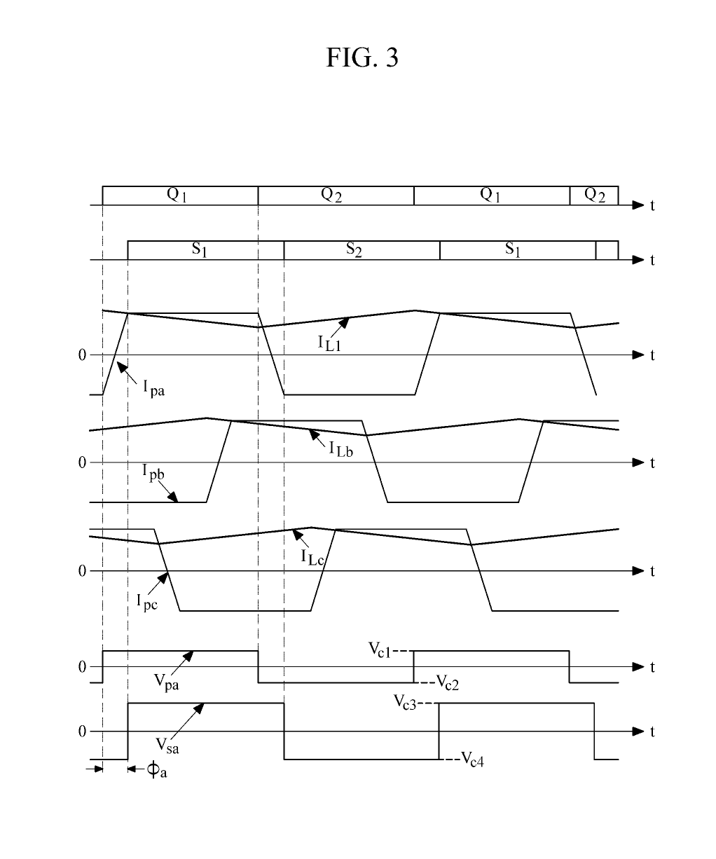

FIG. 2 is a circuit diagram illustrating an example of a 3-phase interleaved bidirectional DC-DC converter, and FIG. 3 is operation waveforms for explaining the operation of the 3-phase interleaved bidirectional DC-DC converter.

Referring to FIG. 2, the 3-phase interleaved bidirectional DC-DC converter includes a 3-phase high frequency transformer with Y-Y connection at both primary and secondary side. The primary side of the 3-phase high frequency transformer includes an energy storage module Vᵢ, three input inductors Lₐ, L_{b} and L_{c} and three half-bridges. The three half-bridges include first through sixth switches Q₁ through Q₆ and first and second capacitors C₁ and C₂ at the primary side. In this case, one ends of the primary sides of the 3-phase high frequency transformer are connected to the contacts a, b and c of the corresponding half-bridges. Also, the other ends of the primary sides of the 3-phase high frequency transformer are connected in common to the contact m of the first and second capacitors C₁ and C₂.

Meanwhile, the secondary side of the 3-phase high frequency transformer includes three half-bridges and an output capacitor C₀. The three half-bridges include first through sixth switches S₁ through S₆, and third and fourth capacitors C₃ and C₄ s at the secondary side. An output capacitor C₀ is connected to one ends of the third and fourth capacitors C₃ and C₄. One ends of the secondary sides of the 3-phase high frequency transformer are connected to the contacts a′, b′ and c′ between the corresponding switches S₁ through S₆, and the other ends of the secondary sides of the 3-phase high frequency transformer are connected to the contact m′ of the third and fourth capacitors C₃ and C₄.

FIG. 3 is waveforms for explaining the theoretical operation of the 3-phase interleaved bidirectional DC-DC converter illustrated in FIG. 2. Referring to FIGS. 2 and 3, in the 3-phase interleaved bidirectional DC-DC converter, the first switch Q₁ at the primary side and the first switch S₁ at the secondary side have turn-on times. I_{La}, k_{Lb} and I_{Lc} respectively represent inductor currents flow through a-phase, b-phase and c-phase input inductors Lₐ, L_{b} and L_{c}, and Iₚₐ, I_{pb} and I_{pc} represent primary side currents of the 3-phase high frequency transformer. Vₚₐ represents an a-phase primary voltage of the 3-phase high frequency transformer, and Vₛₐ represents an a-phase secondary voltage of the 3-phase high frequency transformer. V_{c1} represents a voltage across the first capacitor C₁, V_{c2} represents a voltage across the second capacitor C₂, V_{c3} represents a voltage across the third capacitor C₃, and V_{c4} represents a voltage across the fourth capacitor C₄.

There is a phase shift φₐ between the a-phase primary square wave voltage Vₚₐ and a-phase secondary square wave voltage Vₛₐ of the transformers. The phase shift (φₐ, φ_{b}, φ_{c}) between the primary and the secondary determines the amount of power transmitted through the multi-phase interleaved bidirectional DC-DC converter. An each-phase half-bridge operates at a duty ratio of 50%.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-phase interleaved bidirectional DC-DC converter comprising:
a first bidirectional DC-DC converter including an input unit which includes an energy storage module and a first input inductor storing input current from the energy storage module, a first primary half-bridge which is connected to the first input inductor and controls the input current from the energy storage module, an output unit which includes an output capacitor, a first secondary half-bridge which is connected to the output unit and controls the output voltage, and a first transformer whose primary side is connected to the first primary half-bridge, whose secondary side is connected to the first secondary half-bridge, and which transforms a voltage at the primary side or at the secondary side according to a power mode; and
a n-th bidirectional DC-DC converter including a n-th input inductor which stores input current from the energy storage module, a n-th primary half-bridge which is connected to the n-th input inductor and controls the input current from the energy storage module, a n-th secondary half-bridge which is connected to the output unit of the first bidirectional DC-DC converter and controls the output voltage, and a n-th transformer whose primary side is connected to the n-th primary half-bridge, whose secondary side is connected to the n-th secondary half-bridge, and which transforms a voltage at the primary side or at the secondary side according to a power mode,
wherein the n-th bidirectional DC-DC converter is composed of one or more n-th bidirectional DC-DC converters.

2. The multi-phase interleaved bidirectional DC-DC converter of claim 1, wherein the first bidirectional DC-DC converter further comprises an output capacitor,
the first input inductor of the input unit is connected to the energy storage module,
the first primary half-bridge includes a first primary switch connected to the first input inductor, a second primary switch, a first capacitor, and a second capacitor,
the first secondary half-bridge includes a first secondary switch, a second secondary switch, a third capacitor, and a fourth capacitor, which are connected to the output capacitor, and
the primary-side one end of the first transformer is connected to a contact of the first primary switch and the second primary switch, the primary-side other end of the first transformer is connected to a contact of the first capacitor and the second capacitor, the secondary-side one end of the first transformer is connected to a contact of the first secondary switch and the second secondary switch, and the secondary-side other end of the first transformer is connected to a contact of the third capacitor and the fourth capacitor.

3. The multi-phase interleaved bidirectional DC-DC converter of claim 2, wherein the n-th bidirectional DC-DC converter further comprises an output capacitor,
the n-the input inductor is included in the input unit and connected to the energy storage module,
the n-th primary half-bridge includes a n-th primary switch connected to the n-th input inductor, a (n+1)-th primary switch, the first capacitor, and the second capacitor,
the n-th secondary half-bridge includes a n-th secondary switch, a (n+1)-th secondary switch, the third capacitor, and the fourth capacitor, which are connected to both terminals of the output capacitor, and
the primary-side one end of the n-th transformer is connected to a contact of the n-th primary switch and the (n+1)-th primary switch, the primary-side other end of the n-th transformer is connected to a contact of the first capacitor and the second capacitor, the secondary-side one end of the n-th transformer is connected to a contact of the n-th secondary switch and the (n+1)-th secondary switch, and the secondary-side other end of the n-th transformer is connected to a contact of the third capacitor and the fourth capacitor.

4. A 3-phase interleaved bidirectional DC-DC converter comprising:
an energy storage module;
three input inductors connected in parallel to each other and connected to the energy storage module;
three primary half-bridges connected to the three input inductors, respectively;
an output capacitor;
three secondary half-bridges connected to both terminals of the output capacitor and provided respectively in correspondence to the three primary half-bridges; and
a 3-phase high frequency transformer connected to the three primary half-bridges and the three secondary half-bridges in a Y-Y connection form.
